(19) United States
(12) Patent Application Publication
(10) Pub. No.: US 2024/0293998 A1
(43) Pub. Date: Sep. 5, 2024

(54) CHEMICALLY STRENGTHENED LAMINATE WITH OBSCURATION AND METHOD OF MANUFACTURE

(71) Applicant: AGP America S.A., Ciudad de Panama (PA)

(72) Inventors: Jorge A. RAMOS, Lima (PE); Alfredo D. KOC, Lima (PE); Vincenzo MANNINO, Lima (PE)

(21) Appl. No.: 18/573,799

(22) PCT Filed: Jun. 29, 2022
(86) PCT No.: PCT/IB2022/056083

§ 371 Date: Dec. 22, 2023

Related U.S. Application Data
(60) Provisional application No. 63/216,494, filed on Jun. 29, 2021.

(51) Int. Cl. B32B 17/10

(52) U.S. Cl. CPC B32B 17/10036; B32B 17/10137; B32B 17/10348; B32B 2250/03; B32B 2250/40; B32B 2309/02; B32B 2309/12; B32B 2309/68; B32B 2315/08

(57) ABSTRACT

The use of chemically strengthened glass, which was once only found in low volume specialty applications, is growing as a rapid rate as more and more new applications are found for it. Today, it can be found on the screens of hundreds of millions of smart, phones, tablets, and other devices. The high strength, scratch resistance, light weight and optical clarity also make it an especially attractive material for automotive vehicles where it is just starting to find uses. One of the challenges faced when fabricating an automotive laminate with chemically strengthened glass is in the application of the obscuration needed to hide the mounting adhesive and trim. Conventional black frits are not compatible with the chemical strengthening process. Porous frits, on the contrary, which allow the chemical strengthening to take place, have poor aesthetics. The disclosure provides a process for producing a laminated glazing with at least one chemically strengthened glass layer with a glossy black frit obscuration as well as the laminate itself.

### TECHNICAL FIELD

The disclosure relates to the field of automotive glazing.

### BACKGROUND ART

In response to the regulatory requirements for increased automotive fuel efficiency as well as the growing public awareness and demand for environmentally friendly products, automotive original equipment manufacturers, around the world, have been working to improve the efficiency of their vehicles. One of the key elements of this strategy to improve efficiency has been the concept of light weighting. By reducing the weight of the vehicle substantial improvements can be made in energy consumption. This is especially important for electric vehicles where the improvement directly translates into an increase in the range of the vehicle which is a key consumer concern.

In the process, more traditional, less expensive, conventional materials and processes are often being replaced by innovative new materials and processes which while sometime being more expensive, still have higher utility than the materials and processes being replaced due to their lower weight and the corresponding increase in fuel efficiency. Sometimes, the new materials and processes bring with them added functionality as well in addition to their lighter weight. Vehicle glazing has been no exception.

The glazed area of many models of vehicles has been steadily increasing. The popular large glass panoramic roofs are just one example of this trend. On new cars, the panoramic roof has become a popular option that has seen rapid growth over the last several years and is expected to accelerate. A panoramic roof is a roof that is comprised substantially of glass. The roof glazing may be comprised of a single or multiple glazings. The large panoramic glass roof gives the vehicle an airy and luxurious look.

Panoramic windshields are also increasing in popularity. A panoramic windshield is a windshield on which the top edge has been substantially extended such that it comprises a portion of the vehicle roof.

The increase in the glazed area also helps to offset the cramped and claustrophobic feel that can result from a reduction in the passenger compartment volume. The increase in natural light and viewing area give the vehicle the feel of a larger interior.

In addition to the increase in the glazed area, the glazing has been getting thinner. For many years, the standard automotive windshield had a thickness of 5.4 mm. In more recent years, we have seen the thickness decrease to 4.75 mm. While a reduction of 0.65 mm may not seem significant, at a density of 2,600 kg per cubic meter for the typical standard soda-lime float glass, each millimeter that the thickness is reduced, decreases the weight by 2.6 kg per square meter. The weight of a typical 1.2 square meter windshield going from 5.4 mm to 4.75 mm is reduced by a little over 2 kg. On a vehicle with a total of 6 square meters of glass, a 1 mm reduction on all the windows translates into a savings of 15.6 kg. However, there are limits as to how thin the glazing can be using annealed soda-lime glass. Stress under wind load has always been a factor. With the trend towards increasing the size of windshields, wind load is even more of a concern. Glass is also becoming a structural element in more and more vehicles. The glazing contributes to the stiffness and strength of the car. Fixed glass, once bonded with a relatively soft curing polyurethane, is being mounted with higher modulus adhesives. As a result, the glass, once isolated by rubber gaskets and soft butyl adhesives, is now much more subjected to loading from the bumps in the road and vehicle torsion.

Today, windshields with a 2.1 mm outer ply, a 1.6 mm inner ply and a 0.76 mm plastic bonding layer known as interlayer totaling just under 4.5 mm in total thickness are becoming common. This may be close to the limit of what can be done with conventional annealed soda-lime glass.

To further reduce weight, different processes and materials are needed.

By using a stronger material, the thickness can be reduced. This principle has been used extensively in automotive design. High strength steel is now used extensively to fabricate critical body panels. In the same way, high strength glass allows for thinner and lighter glass layers to be used.

Glass is synonymous with fragile. Stickers with an icon of a drinking glass are placed on packages containing articles that are easily broken. Most of the common glass items and glazing that we encounter in everyday life is easily broken when dropped or impacted.

Metals and many other types of materials have an ultimate yield strength at which point the material will fail. However, with glass we can only specify a probability of breakage for a given value of stress. Looking at glass at the molecular level, we would expect the strength to be extremely high. In fact, what we find in practice is that glass has an extremely high compressive strength, as expected, but extremely low tensile strength.

For a given set of glass test specimens, with identical loading, the point of failure will have a wide range and a lot of variation. At first glance the yield point might appear to be a random variable. In fact, the yield point follows a Weibull distribution, and the probability of breakage can be calculated as a function of, stress, duration, surface area, surface defects and the modulus of glass.

To the naked eye, float glass appears to be near perfect. Any defects that may be present is so small as to not be visible. But, in fact, at the microscopic level, the surface appears rough and can be seen to be dotted with flaws. When the is placed in tension, these surface defects tend to open and expand, eventually leading to failure. Therefore, laminated automotive glass almost always fails in tension. Even when not in tension, the surface defects react with the moisture in the environment and slowly “grow” over time. This is known as slow crack growth.

Fortunately, we can take advantage of the high compressive strength of glass by means of two methods which place the outer surfaces of the glass in compression. These are heat strengthening and chemical strengthening. Rather than “strengthening” the process as sometime referred to as “toughening” or “tempering”. In general, in the automotive industry, tempered refers to a glazing that has been tempered to the level required to meet regulatory requirements for tempered safety glass while toughened or strengthened is glass that has been treated but does not meet full temper requirements.

Heat strengthened, full temper soda-lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed glass. The lower thickness limit of the typical automotive heat strengthening process is in the 3.2 mm to 3.6 mm range for full temper. This is due to the rapid heat transfer that is required. It is not possible to achieve the high surface compression needed with thinner glass using the typical blower type low pressure air quenching systems in common use. Chemical strengthening can be used to achieve high levels of compression and on much thinner glass.

Laminated glazing has been produced comprising a standard thickness outer glass layer laminated to a thin chemically strengthened inner glass layer resulting in a substantial reduction in weight. Another benefit of this thin cross section is that it has been found to be much more resistant to impact damage than a standard thickness laminate with the exact same outer glass layer. The thinner glazing tends to deform upon impact dissipating the energy over a larger area than the stiffer and thicker laminate. This benefit alone can justify the higher cost of the chemically strengthened glass.

There are some drawbacks to the chemical strengthening process that have hindered widespread automotive use. The application of a black obscuration is one such limitation.

Laminated automotive glazing generally requires a back print to hide the adhesive, interior trim and items that may be mounted to the glazing. A black obscuration band is typically printed onto at least one of the major surfaces of the glazing. It is common to find an obscuration printed on both the inner and the outer glass layers of a windshield. The paint or ink used to print the obscuration is known as frit.

The frit used for automotive laminates has been specifically developed for use on soda-lime automotive glass. There are several companies that manufacturers frit as well as several types of frit.

The black frit is printed on the flat glass prior to bending. During the bending process, the frit is said to be “fired” in a vitrification process during which the frit partially melts and is in effect welded to the glass surface.

Chemically strengthened glass undergoes an ion exchange process. If the surface of the glass to be treated is covered with any type of material that will block the ion exchange, the process will not be successful. A conventional frit cannot be used for this reason. The areas covered by the frit would not be strengthened.

To solve this problem, one solution has been to apply an organic paint after bending and chemical strengthening. This is undesirable as the organic paint is not as durable as a frit and it is far more expensive to apply the paint to the glass. Another solution that has been developed in recent years is a frit that is porous. The glass is painted with the porous frit and then the glass is heated to fire the frit. The frit is made by mixing a liquid polymer in with the pigments and other ingredients. After the frit is applied to the glass, the polymer is cross linked forming a matrix structure. During firing the polymer is burnt off leaving behind a porous structure.

The porous structure allows for the molten salt to penetrate the frit and reach the glass surface. It is also durable enough to survive the strengthening process. The primary drawback to this process is the aesthetics. The finished product has an inconsistent mottled grey appearance rather than the deep glossy black of the typical automotive black frit. In applications where appearance is important, it has been found that the appearance can be improved substantially by filling the pores with a liquid resin. While this does work, it is an expensive, time consuming process, comparable to applying an organic black ink, and still not as durable as a black frit.

When the porous frit is used in a laminate where the frit is printed on one of the surfaces in contact with the plastic bonding layer, the appearance is even worse. The plastic bonding layer will partially fill the pores in the frit giving it a very inconsistent and even more mottled appearance.

It would be desirable to have a means to apply an obscuration prior to chemical strengthening that did not have these disadvantages.

### BRIEF SUMMARY OF THE DISCLOSURE

The disclosure comprises a chemically strengthened laminate with obscuration and method of manufacture. The laminate has at least one chemically strengthened glass layer with said layer having a black ion exchange compatible porous frit obscuration printed upon one of the major faces of said layer which will be an internal surface of the laminate in contact with the plastic bonding layer. Said glass layer with obscuration is assembled with a layer of transparent plastic bonding layer placed between said glass layer and the other layers of the laminate. The assembled laminate is then processed by means of a modified lamination process. The modified process allows said plastic bonding layer to fill the pores of the frit resulting in a glossy black appearance. The modified lamination process parameters include an unexpected and surprising reduction in the prelamination temperature and a reduction in the autoclave pressure.

### Advantages

No extra process steps required.
Only standard automotive laminating equipment needed.
No extra fillers required.
Superior aesthetics.
Lower cost than resin filled porous frit.
Lower cost than organic black ink.

### BRIEF DESCRIPTION OF THE DRAWINGS

FIGS. 1A and 1B show the cross section of a laminated glazing.

FIG. 1C shows the cross section of a conventional monolithic glazing.

FIG. 2 shows an exploded view of the laminated glazing such as of FIGS. 1A and 1B.

FIG. 3A shows the cross section of a laminated glazing stack assembled before the process of lamination.

FIG. 3B shows the cross section of a laminated glazing after lamination using conventional autoclave parameters such as nominal temperature, pressure and time.

FIG. 3C shows the cross section of a laminated glazing after lamination using autoclave parameters according to this disclosure.

FIG. 4 shows a table with lamination parameters such as temperature, pressure and time as discussed in this disclosure.

### REFERENCE NUMERALS OF DRAWINGS

2 Glass
4 Plastic bonding layer
6 Conventional obscuration frit
8 Porous obscuration frit
12 Film
14 Nominal pore filling depth
16 Interface
18 Coating
101 Surface one
102 Surface two
103 Surface three
104 Surface four
201 Outer layer
202 Inner layer

### DETAILED DESCRIPTION OF THE DISCLOSURE

The present disclosure can be understood by reference to the detailed descriptions, drawings, examples, and claims, of this disclosure. However, it is to be understood that this disclosure is not limited to the specific compositions, articles, devices, and methods disclosed unless otherwise specified and as such can, of course, vary. It is also to be understood that the terminology used herein is for the purpose of describing aspects only and is not intended to be limiting. The following terminology is used to describe the laminated glazing of the disclosure.

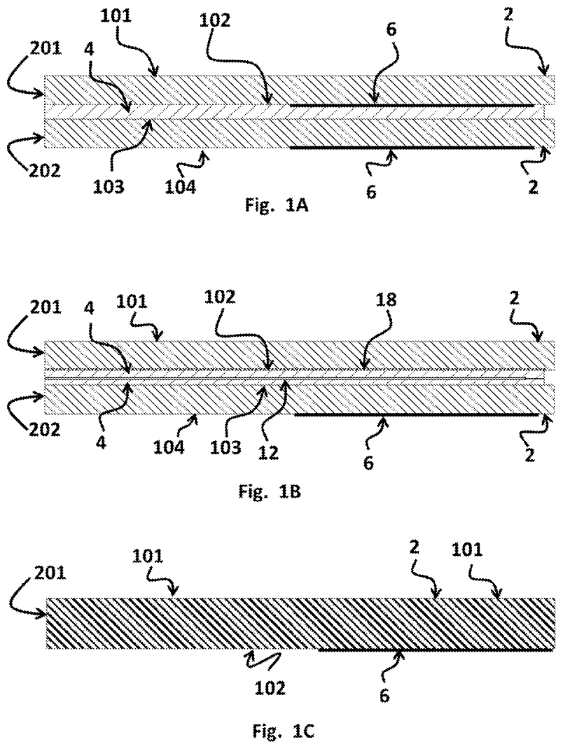

Typical automotive laminated glazing cross sections are illustrated in FIGS. 1A and 1B. A laminate is comprised of two layers of glass, the exterior or outer, 201 and interior or inner, 202 that are permanently bonded together by a plastic layer 4 (plastic bonding layer). In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. An obscuration 6 may be also applied to the glass. Obscurations are commonly comprised of black frit printed on either the number two 102 or number four surface 104 or on both. The laminate may have a coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black frit printed on the number two 102 surface. The glazing may have a coating 18 on the number one 101 and/or number two 102 surfaces. The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

Most of the worlds' flat glass is produced by the float glass process, first commercialized in the 1950s. In the float glass process, the raw ingredients are melted in a large refractory vessel and then the molten glass is extruded from the vessel onto a bath of molten tin where the glass floats. The thickness of the glass is controlled by the speed at which the molten glass is drawn from the vessel. As the glass cools and hardens, the glass ribbon transfers to rollers. Float glass thickness can typically vary by +/50 μm over a short distance due to what is known as draw line distortion. This is caused by the mechanical means used to draw the molten glass extruded from the vessel into a thin ribbon on the flat glass float line.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Most of the glass used for containers and windows is soda-lime glass. Soda-lime glass is made from sodium carbonate (soda), lime (calcium carbonate), dolomite, silicon dioxide (silica), aluminum oxide (alumina), and small quantities of substances added to alter the color and other properties.

Borosilicate glass is a type of glass that contains boric oxide. It has a low coefficient of thermal expansion and a high resistance to corrosive chemical. It is commonly used to make light bulbs, laboratory glassware, and cooking utensils.

Aluminosilicate glass is made with aluminum oxide. It is even more resistant to chemicals than borosilicate glass and it can withstand higher temperatures. Chemically strengthened Aluminosilicate glass is widely used for displays on smart phones and other electronic devices.

Lithium-Aluminosilicate is a glass ceramic that has exceptionally low thermal expansion, optical transparency and high. It typically contains 3-6% Li₂O. It is commonly used for fireplace windows, cooktop panels, lenses and other applications that require low thermal expansion.

Flat glass is also produced by another method, the fusion or overflow downdraw method. The method has the advantage is that the glass surfaces never come in contact with molten tin as in the float glass process. The fusion method was originally developed in the 1960s as a low-cost method for manufacturing optically superior glass for automotive windshields but was replaced by the float glass method. Previously windshield had been made from plate glass which required grinding and polishing to improve the optical quality of the glass. The technology was reintroduced to produce very thin glass for the flat screen display market. A sheet of glass is formed when molten glass overflows from a supply trough, flows down both sides, and rejoins (fuses) at the tapered bottom, where it is drawn away in sheet form.

The thin chemically strengthened glass of the disclosure is primarily produced by the fusion method.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Safety glass is glass that conforms to all applicable industry and government regulatory safety requirements for the application.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Laminated safety glass is made by bonding two layers (201 & 202) of annealed glass 2 together using a plastic bonding layer comprised of a thin sheet of transparent thermoplastic interlayers.

The plastic bonding layer 4 (interlayer) has the primary function of bonding the major faces of adjacent layers to each other. The material selected is typically a clear thermoset plastic.

For automotive use, the most used plastic bonding layer 4 is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB plastic bonding layer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive plastic bonding layers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil) as shown in FIG. 1A and FIG. 1B.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

The glass layers may be annealed or strengthened. There are two processes that can be used to increase the strength of glass. They are thermal strengthening, in which the hot glass is rapidly cooled (quenched) and chemical strengthening which achieves the same effect through an ion exchange chemical treatment.

In the chemical tempering process, ions in and near the outside surface of the glass are exchanged with ions that are larger. This places the outer layer of glass in compression. Compressive strengths of up to 1, 000 MPa are possible. The typical methods involved submerging the glass in a tank of molten salt where the ion exchange takes place. The glass surface must not have any paint or coatings that will interfere with the ion exchange process.

The black frit print obscuration on many automotive glazings serves both a functional and an aesthetic role. The substantially opaque black print on the glass serves to protect the poly-urethane adhesive used to bond the glass to the vehicle from ultra-violet light and the degradation that it can cause. It also serves to hide the adhesive from view from the exterior of the vehicle. The black obscuration must be durable, lasting the life of the vehicle under all exposure and weather conditions. Part of the aesthetic requirement is that the black has a dark glossy appearance and a consistent appearance from part to part and over the time. A part produced today must match up with one that was produced and in service 20 years ago. The parts must also match up with the other parts in the vehicle which may not have been fabricated by the same manufacturer or with the same formulation of frit. Standard automotive black frits (inks or paints) have been developed that can meet these requirements.

Black frit is comprised of pigments, carriers, binders, and finely ground glass. Other materials are also sometimes added to enhance certain properties: the firing temperature, anti-stick, chemical resistance, etc. The black frit is applied to the glass using a silk screen or ink jet printing process prior to the heating and bending of the glass. As the flat glass is heated during the bending process, the powdered glass in the frit softens and melts, fusing to the surface of the glass. The black print becomes a permanent part of the glass. The frit is said to be “fired” when this takes place. This is a vitrification process which is like the process used to apply enamel finishes on ceramic bathroom fixtures, pottery, porcelain artifacts, and appliances.

Other means are sometimes used to provide an obscuration when a black frit is not practical as is the case when the substrate will be chemically strengthened, or the surface has been coated with a coating that is not compatible with the printing process. These include but are not limited to organic inks, primers, and inserts.

The word “nominal” will be used to describe a process parameter that is within acceptable or expected boundaries. In the claims, the word nominal shall reference the normal value or range of values that a parameter would take on if the exact same laminated part were being made with a standard black frit. The nominal value are the optimized parameter values that would be used in series production. Production process parameters are optimized to minimize cost. The innovation of the disclosure is claimed in terms of the counter-intuitive and surprising deviations from nominal.

Heuristic means were used to discover the method used to produce the laminate of the disclosure. Bent sets of glass were produced with a 2.3 mm soda-lime annealed outer 201 glass layer and a 1.2 mm aluminosilicate inner glass 202 layer. The inner glass layer 202 was screen printed with a porous black frit designed for chemical strengthening. The painted, fired, and bent, inner glass layer was then chemically strengthened.

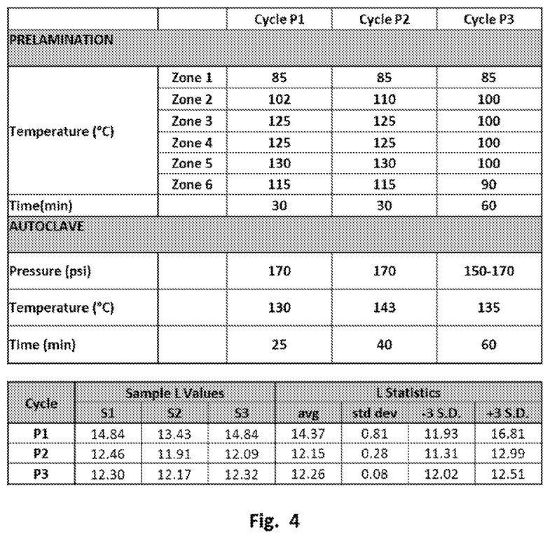

A design of experiments was used to zero in on the best settings. A select set of the experimental results are shown in FIG. 4. The parameter sets tested are labeled P1, P2, and P3. While many combinations of parameter sets were tested, only some are shown. P1 and P2 are the actual values used for actual series production parts with standard black frit. None of these resulted in the deep glossy black aesthetic that is required. P3 is an example of a parameter set that produces the deep glossy black appearance required. Surprisingly, lower prelamination temperatures and lower autoclave pressures were required to get complete penetration and filling of the pores in the frit.

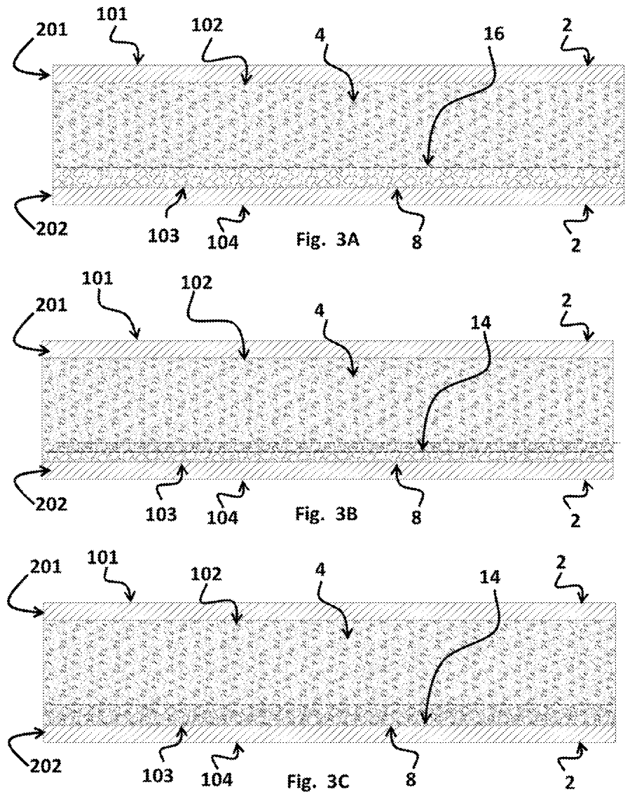

In FIG. 3A two glass 2 layers are shown, the inner 202 and the outer 201 layer. Surface three 103 of the inner 202 layer is painted with a porous frit as an obscuration 6. The thicknesses of the glass layers, the porous frit and the plastic bonding layer are exaggerated merely for the purposes of illustration. The interface 16 between the plastic bonding layer 4 and the obscuration 6 is shown prior to lamination. In FIG. 3B, the cross section after lamination, using nominal lamination parameters is shown. The plastic bonding layer has penetrated and filed the pores of the obscuration frit to the nominal pore filling depth 14 as shown in FIG. 3B. The resulting color of the frit is grey and does not comply with the product target specifications. This problem is intensified by the frit thickness inconsistency due to the process used for applying the frit. Conventionally screen printing is the method of choice for applying frit in automotive glazing due to its low cost of equipment, scalability and high quality results. However, when using screen printing, the thickness of the paint varies as a function of the screen thread diameter and thread spacing. The other screen print parameters, including viscosity, squeegee angle, pressure and durometer also play a role on the printed frit thickness. As a result, the thinner portions tend to be darker than the thicker portions even if the difference is on the micron level. This just makes the aesthetic of the semi-filled pore glazing even worse. FIG. 3C shows the complete penetration and filing of the frit pores by the modified lamination process of the disclosure. The pores are completely filed by the plastic bonding layer 4 below the nominal pore filling depth 14 all the way to the glass surface and the aesthetics comply with product specifications.

The lamination process disclosed in this disclosure has a number of steps. The first part of the process is assembly of the layers and it is unchanged compared to a conventional process. The glass layers and interlayers are assembled in a clean room.

The next part of the process is the prelamination step. The prelamination process removes air from the assembled laminate and adheres the glass layers to the interlayer. At this point the laminate has been permanently bonded but is not yet transparent.

There are two common prelamination methods in use in the automotive glass industry. The most common is the pinch roll process which is used on laminates with simpler curvature, and which only have a single sheet of interlayer and nothing else inside of the laminate. The assembled laminate is heated in an oven to soften the interlay and make it tacky. The heated laminate is then passed through a set of rollers to pinch the plies together and to force any air out of the laminate.

For the more complex shapes such as multiple interlayer sheets and laminates with antennas, heated circuits, LEDs, sensors, etc., a vacuum process is used. In the vacuum prelamination process, the assembled laminate is placed inside of a bag or a channel is installed around the periphery of the laminate. The bag or channel is then connected to a vacuum source evacuating any air between the layers of the laminate. The laminate is loaded onto a rack and enters an oven where it is heated. The heat softens the interlayer while the vacuum removes the air and presses the glass layers together. When the laminate cools, the glass layers will remain firmly bonded to each other.

At this point, in either process, the laminate is only translucent as the interlayer will still retain much of its' original surface texture. Further processing is required to turn the interlayer clear.

The next step in the process is the autoclave. The autoclave process is a batch process. The capacity an autoclave can run into several hundreds. The desired laminates from the prelamination step are loaded into racks where they will cool from the prelamination oven temperature while waiting for the autoclave to be filled.

The autoclave is a pressure vessel that heats the laminates while applying pressure. The typical autoclave cycle runs from 20 minutes to one hour for automotive laminates. For thick complex laminates, such as bullet resistant glazing, a cycle lasting several hours may be required. The temperature, pressure and duration are carefully optimized to minimize cost.

Laminates with a porous frit on surfaces 2 or 3 that are processed with standard prelamination and autoclave parameter resulted in the poor aesthetics described. In the experimental results shown in FIG. 4 the prelamination time and temperatures are shown. The prelamination oven is equipped with six zones and a variable speed drive. Parameter sets P1 and P2 used a process time of 30 minutes to convey the laminate through the oven. Parameter set P3, the one that provided the glossy deep black (below the nominal pore filling depth 14), had a time of 60 minutes. We would expect to have better result with the heat and vacuum applied for a longer time. However, that was not the case when the same temperature profile was used. It was discovered that lowering the peak temperatures by about 25° C. produced excellent results.

Likewise, the autoclave parameters modifications were required. The temperature was increased by 5° C. which was expected to help. There is a limit on how high of a temperature can be used as the interlayer will degrade if processed as too high of a temperature. The maximum allowable will depend upon the specific interlayer used and the process duration. We would have expected to have better results with a higher autoclave pressure. In fact, reducing the pressure by up to 25 psi from nominal improved the aesthetics.

To summarize, the deep glossy black with near complete filling of the black frit pores, where the penetration of the plastic bonding layer reached below the nominal pore filling depth, was accomplished by means of a prelamination process in which the process time was increased by up to 100% and the maximum temperature was reduced by up to 25° C. The autoclave duration remained approximately the same as nominal, the nominal temperature was increased by up to 5° C. and the pressure was decreased by up to 25 psi from nominal.

The mechanism by which the disclosure works is intimately related to the plastic bonding layer viscosity and additive evaporation. It has been observed that the higher temperatures during the prelamination step, the interlayer begins to flow and starts to fill the voids. However, the vacuum does not provide enough force to drive the viscous interlayer completely into the pores. While waiting for the start of the autoclave process, the laminate cools and some of the plasticizer in the interlayer that has been forced into the pores, evaporates or is leeched out by capillary action. When the glass is reheated in the autoclave, the interlayer in the pores is no longer as viscous and acts as a plug preventing the interlayer from further filling the pores.

When processed at the lower prelamination temperature, the plastic bonding layer reaches an optimal viscosity and becomes sufficiently tacky to adhere to the glass layers. The air is evacuated but the plastic bonding layer does not start to flow into the pores. Once in the autoclave, the higher temperature allows the interlayer to flow into the pores. The lower pressure allows this to take place at a slower rate to more completely fill the voids. It has been discovered that time rather than higher temperatures result in improved obscuration aesthetics.

While the aesthetic required is somewhat subjective in that it is easily identified when it is not present, we do have an objective measurement that we can use to compare and evaluate. Colors can be described in terms of their lightness, chroma or saturation, and hue. A number of different systems have been developed to express these values. The CIE1979 L*a*b* color space is a 3-dimensional rectangular color space based on Opponent-Colors Theory where: L* (lightness), 0 is black, 100 is white, and 50 is middle gray, a* (red-green) positive values are red, negative values are green, and 0 is neutral, and b* (blue-yellow) axis-positive values are yellow, negative values are blue, and 0 is neutral. For the present disclosure L*a*b* color coordinates are calculated based in the CIE1976 L*a*b* color space using sample's reflection spectral data, with specular component excluded, measured with a spectrophotometer coupled with an integrating sphere. For automotive glazing application acceptable values of the color parameter L for black obscuration/band range below 15, preferably L below 13.

The chart of FIG. 4 shows the L values measured from a set of three samples from each of the select sets of test conditions. There is a difference between the average L value of the disclosure and those of the samples process using the conventional lamination cycle of over 2 points. Parameter set P2, with the autoclave process temperature of 143° C., had an L value that was a little less than P3. One interesting observation is that the ratio of the standard deviation of the L values of P1 and P2 toon as compared to the L values of the disclosure range from about 3.5 to 10 times greater. This indicates that the other cycles are achieving only partial saturation of the frit pores which while in some instances can result in a comparable L value on average, has far more variation than that of the disclosure.

The nominal parameter set that works well with ordinary frit clearly does not work with the porous frit. Parameters for use with a pinch roller type of prelamination process have not been tested however should follow in the same pattern.

Many attempts have been tried to solve this problem trying to find means to get standard interlayers and lamination processes to work but have failed to find a solution as the one disclosed by the present disclosure. The prior art has only disclosed the porous frit and resin fill discussed. Others may have failed due to the fact that the intuitive change would be to increase the duration, temperature and pressure which we have not found to be successful.

### EXAMPLES

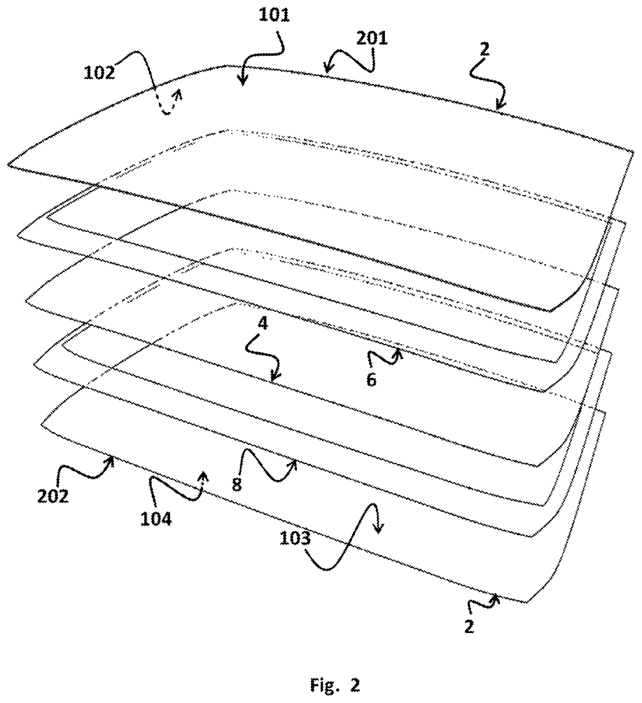

Example one: is shown in the exploded view of FIG. 2. The laminate is a windshield. The outer 201 glass layer is made of a 2.3 mm thick solar green soda-lime glass 2. A conventional black frit obscuration 6 is printed on surface two 102 of the outer glass layer 201 using a conventional soda-lime glass frit 6. An 0.76 mm plastic solar control interlayer 4 is used. The inner glass layer 202 is comprised of 0.7 mm aluminosilicate glass. The flat glass is cut to size and then screen printed with a porous black frit 8 on surface three 103. Both frits are cured by reaching their firing temperature and then the glass sheets are bent. The inner glass layer 202 with the cured porous frit is subjected to chemical strengthening in a molten potassium nitrate salt bath at a conventional temperature and for a typical time. The bent sets are assembled with the interlayer 4. The assembled laminated is processed using a vacuum channel prelamination process followed by an autoclave process. Parameter set P3 is used. The pores are filled with the plastic solar control interlayer below the nominal pore filling depth 14. Thus, the black obscuration 8 on the inner glass layer 202 has a deep glossy and consistent black color, indistinguishable from the conventional black frit used on the outer 201 glass layer.

Example two: is similar to Example one except that there is no conventional black frit obscuration 6 printed on surface two 102.

Example three: is similar to any one of the Examples above wherein the color parameter L of the porous black frit obscuration is below 13, more preferably below 12.

It must be understood that the present disclosure is not limited to the examples and embodiments described and illustrated, as it will be obvious for an expert on the art, there are different variations and possible modifications that do not strive away from the disclosure's essence, which is only defined by the following claims.

1. An automotive laminate, comprising:
at least two glass layers, wherein at least one of them is chemically strengthened;
at least one plastic bonding layer; and
a porous frit obscuration cured at its firing temperature and having a nominal pore filling depth on the chemically strengthened glass layer;
wherein said at least one plastic bonding layer fills the pores of the porous frit obscuration below the nominal pore filling depth when processed by means of:
an autoclave process, wherein:
the temperature is up to 5° C. higher than the nominal temperature of the frit obscuration; and
the pressure is up to 5 psi less than the nominal pressure of the frit obscuration.

2. The automotive laminate of claim 1, wherein a prelamination step occurs before the autoclave process, wherein:
said laminate is heated to a temperature that is at least 5° C. lower than the nominal temperature of the frit obscuration; and
the process time is increased by up to 25% greater than the nominal of the frit obscuration.

3. The automotive laminate of any one of the preceding claims wherein the porous frit obscuration has a color parameter L* of below 13, preferably 12.

4. A method of producing the automotive laminate of claim 1, comprising the steps of:
pre-laminating by heating the laminate to a temperature that is up to 5° C. less than the nominal of a conventional frit obscuration; and
carrying out an autoclave processing by heating the laminate to a temperature that is up to 5° C. greater than the nominal of a conventional frit obscuration and applying a pressure that it up to 5 psi less than the nominal of a conventional frit obscuration.

5. The method of claim 4, further comprising a vacuum prelamination process.

6. The method of claim 4, wherein the prelamination process temperature is 5 up to 10° C., or up to 15° C., or up to 20° C., or up to 25° C. lower than nominal of a conventional frit obscuration.

7. The method of claim 4, wherein the prelamination process temperature is at least 25° C. lower than nominal of a conventional frit obscuration.

8. The method of claim 4, wherein the prelamination process time is up to 50%, or up to 75%, or up to 100% greater than nominal of a conventional frit obscuration.

9. The method of claim 4, wherein the prelamination process time at least 100% greater than nominal of a conventional frit obscuration.

10. The method of claim 4, wherein the autoclave process time is up to 25%, or up to 50%, or up to 75%, or up to 100% greater than nominal of a conventional frit obscuration.

11. The method of claim 4, wherein the autoclave process time at least 100% greater than nominal of a conventional frit obscuration.

12. The method of claim 4, wherein the autoclave temperature is up to 5° C., or up to 10° C. greater than nominal of a conventional frit obscuration.

13. The method of claim 4, wherein the autoclave temperature is at least 10° C. greater than nominal of a conventional frit obscuration.

14. The method of claim 4, wherein the autoclave pressure is up to 10 psi, or up to 15 psi, or up to 20 psi, or up to 25 psi lower than nominal of a conventional frit obscuration.

15. The method of claim 4, wherein the autoclave pressure is at least 25 psi lower than nominal of a conventional frit obscuration.
